(19) United States
(12) Patent Application Publication
(10) Pub. No.: US 2026/0229949 A1
(43) Pub. Date: Aug. 6, 2026

(54) ROTARY ELECTRICAL MACHINE

(71) Applicant: AISIN CORPORATION, Kariya, Aichi (JP)

(72) Inventors: Akifumi KUROKAWA, Kariya-shi (JP); Kiyotaka KOGA, Kariya-shi (JP)

(73) Assignee: AISIN CORPORATION, Kariya, Aichi (JP)

(21) Appl. No.: 19/148,500

(22) PCT Filed: Mar. 6, 2024
(86) PCT No.: PCT/JP2024/008422

§ 371 Date: Jul. 16, 2025

(30) Foreign Application Priority Data
Apr. 13, 2023 (JP) 2023-065508

(51) Int. Cl. H02K 5/08; H02K 15/148

(52) U.S. Cl. CPC H02K 5/08; H02K 15/148

(57) ABSTRACT

This rotary electrical machine includes: a rotor including a shaft; a stator including a stator core and a coil in which a plurality of joining parts that join segment conductors to each other are provided on one side in an axial direction, the coil having a coil end part that protrudes from the stator core to the one side in the axial direction; and a motor housing that covers the rotor and the stator. An insulating part that is disposed between the adjacent joining parts and insulates the adjacent joining parts from each other is provided integrally with the motor housing.

### TECHNICAL FIELD

The present disclosure relates to a rotary electrical machine.

### BACKGROUND ART

Conventionally, a rotary electrical machine including an insulating part that insulates adjacent connecting parts from each other in the connecting parts that electrically connect segment conductors is known. Such a rotary electrical machine is disclosed in, for example, JP 2018-117469 A.

JP 2018-117469 A discloses a rotary electrical machine including: a stator including a coil provided with a plurality of connecting parts (joining parts) that electrically connect segment conductors that protrude from one end of a stator core; a cover that covers the plurality of connecting parts of the coil; and a rotor. The cover described above is attached to the stator core from one side in the axial direction, and covers a coil end part including the connecting parts from the one side in the axial direction. The cover has an insulating part that insulates the adjacent connecting parts from each other. The cover is attached to the stator core to dispose the insulating part between the adjacent connecting parts. The front end position of the insulating part is disposed between the adjacent connecting parts. As a result, the insulating part insulates the adjacent connecting parts from each other. Furthermore, the rotary electrical machine further includes a case that covers the rotor, the stator, and the cover.

### CITATIONS LIST

### Patent Literature

Patent Literature 1: JP 2018-117469 A

### SUMMARY OF DISCLOSURE

### Technical Problems

In the rotary electrical machine described in JP 2018-117469 A, the plurality of connecting parts (joining parts) of the coil are covered with a double layer, that is, both the cover having the insulating part and the case that covers the rotor, the stator, and the cover, which complicates the structure. Note that in the field of rotary electrical machines, it is desired to simplify the structure by eliminating the complexity of the structure.

This present disclosure has been made to solve the above-described problem, and this disclosure provides a rotary electrical machine that can simplify a structure in a configuration in which an insulating part is disposed between adjacent joining parts of a coil for insulation.

### Solutions to Problems

As described above, a rotary electrical machine according to one aspect of this disclosure includes: a rotor including a shaft; a stator including a stator core and a coil in which a plurality of joining parts that join segment conductors to each other are provided on one side in an axial direction, the coil having a coil end part that protrudes from the stator core to the one side in the axial direction; and a motor housing that covers the rotor and the stator, in which an insulating part that is disposed between the plurality of joining parts adjacent to each other and insulates the plurality of joining parts adjacent to each other from each other is provided integrally with the motor housing.

In the rotary electrical machine according to one aspect of this disclosure, as described above, the insulating part that is disposed between the plurality of joining parts adjacent to each other and insulates the plurality of joining parts adjacent to each other from each other is provided integrally with the motor housing that covers the rotor and the stator. As a result, unlike the conventional structure including both a cover having an insulating part and a case that covers a rotor, a stator, and the cover (a structure in which connecting parts are covered with a double layer and the adjacent connecting parts are insulated from each other by the insulating part), the adjacent joining parts can be insulated from each other only by the motor housing in which the insulating part is integrally provided, the motor housing covering the rotor and the stator. As a result, since the number of components of the rotary electrical machine can be reduced, the structure can be simplified in the configuration in which the insulating part is disposed between the adjacent joining parts of the coil for insulation. Furthermore, since a conventional cover is unnecessary, the rotary electrical machine can be downsized. Furthermore, it is not necessary to assemble a double cover as in the conventional art, and the assembly process of the rotary electrical machine can be simplified.

In the rotary electrical machine according to the above-described aspect, preferably, the motor housing includes a hollow housing case having an opening, and a housing cover in which the insulating part is integrally provided, the housing cover being attached to the hollow housing case so as to close the opening, and the housing cover is configured to dispose the insulating part between the plurality of joining parts adjacent to each other by being attached to the hollow housing case.

With this configuration, the insulating part can be disposed between the adjacent joining parts and the adjacent joining parts can be insulated from each other only by attaching the housing cover constituting the motor housing to the housing case.

In this case, preferably, the housing cover includes a resin cover part in which the insulating part is integrally provided, the resin cover part being made of resin, and a metal cover part that supports the shaft, the metal cover part being made of metal.

With this configuration, insulation between the adjacent joining parts can be secured by the resin cover part in which the insulating part is integrally provided, the resin cover part being made of resin, and the shaft can be stably supported by the metal cover part made of metal and having higher rigidity than that of the resin cover part made of resin.

In the rotary electrical machine according to one aspect of this disclosure, as described above, the plurality of joining parts of the coil extend toward the one side in the axial direction separated from the stator core, the coil includes insulating films and the plurality of joining parts from which the insulating films are peeled off, the insulating part protrudes from a motor housing main body toward the other side in the axial direction, and a front end part of the insulating part on the other side in the axial direction extends to a space between the insulating films adjacent to each other beyond the plurality of joining parts.

With this configuration, since the front end part of the insulating part extends to the space between the adjacent insulating films beyond the joining parts, a large insulation distance (separation distance between conductors to be secured so as not to cause a short circuit through the space between the conductors) between the adjacent joining parts can be secured by disposing the insulating part in the entire space between the adjacent joining parts.

The following configurations are also conceivable for the above-described rotary electrical machine.

### (Supplement 1)

For example, in the above-described configuration in which the front end part of the insulating part extends to the space between the adjacent insulating films, preferably, the front end part on the other side in the axial direction of the insulating part is formed to be tapered toward the other side.

With this configuration, the insulating part can be easily inserted and disposed between the adjacent joining parts by using the tapered front end part of the insulating part.

### (Supplement 2)

Furthermore, in the above-described configuration in which the motor housing includes the housing case and the housing cover in which the insulating part is integrally provided, preferably, a recess recessed toward the one side in the axial direction separated from the stator core is provided in an end surface of the housing cover on the stator core side, the insulating part is disposed in a bottom surface portion of the recess on the one side in the axial direction, and the recess is configured such that a refrigerant for cooling the plurality of joining parts flows inside.

With this configuration, the refrigerant flowing through the recess is brought into direct contact with the joining part (conductor) for heat exchange, so that the coil end part can be effectively cooled.

### (Supplement 3)

Furthermore, in the above-described rotary electrical machine, preferably, the insulating part has a plurality of rows of wall parts that extend in respective directions of the radial direction and an axial direction, and is formed in a lattice shape in which the plurality of rows of wall parts partition the plurality of joining parts.

With this configuration, since the plurality of joining parts can be partitioned by the insulating part formed in a lattice shape by the plurality of rows of wall parts, insulation between the adjacent joining parts can be more effectively secured.

### (Supplement 4)

Furthermore, in the above-described configuration in which the motor housing includes the housing case and the housing cover in which the insulating part is integrally provided, preferably, the entire housing cover including the insulating part is made of resin, and the housing cover is configured to dispose the insulating part made of resin between the adjacent joining parts.

With this configuration, the housing cover in which the insulating part is integrally provided can be easily manufactured by resin molding.

### BRIEF DESCRIPTION OF DRAWINGS

FIG. 1 is a cross-sectional view illustrating an entire configuration of a rotary electrical machine according to an embodiment from a radial direction.

FIG. 2 is a cross-sectional view taken along line II-II of FIG. 1.

FIG. 3 is an arrow view taken along line III-III in FIG. 2, and is a view illustrating a stator without illustrating a housing cover.

FIG. 4 is a cross-sectional view taken along line IV-IV of FIG. 2.

FIG. 5 is a diagram for explaining a flow of oil which is a refrigerant in the rotary electrical machine according to the embodiment.

FIG. 6 is a cross-sectional view illustrating a housing cover according to a modification from the radial direction.

FIG. 7 is a cross-sectional view illustrating an entire configuration of a rotary electrical machine including a motor housing according to a modification from the radial direction.

FIG. 8 is a view illustrating a welded portion according to a modification.

### DESCRIPTION OF EMBODIMENTS

Hereinafter, an embodiment will be described with reference to the drawings.

### Embodiment

### (Overall Configuration of Rotary Electrical Machine)

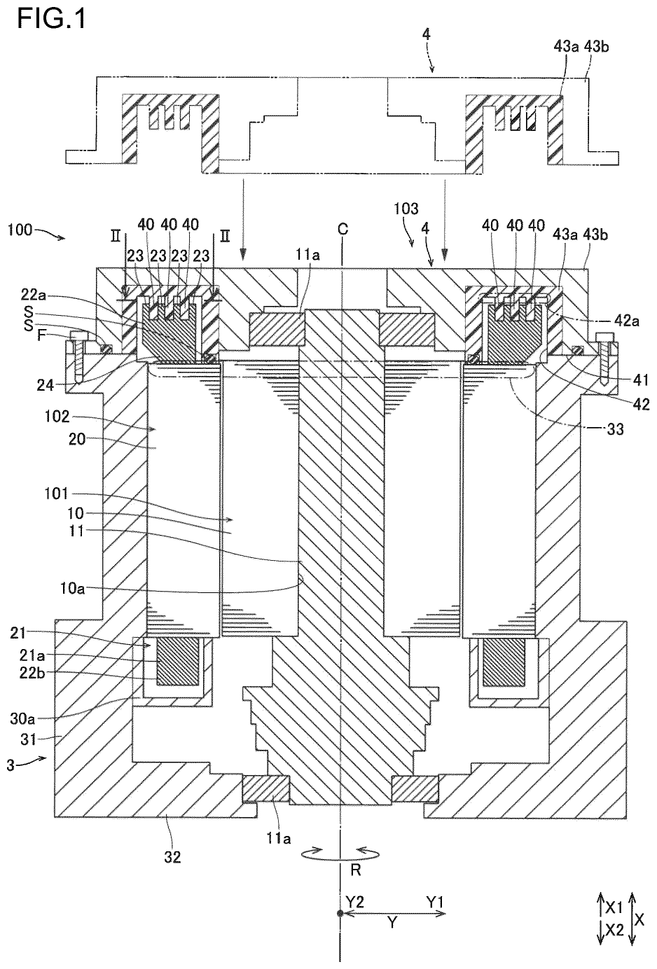

A rotary electrical machine 100 according to an embodiment will be described with reference to FIGS. 1 to 5.

In each drawing, the axial direction of a shaft 11 is indicated by an X direction. Furthermore, a direction from a stator core 20 side toward a joining part 23 side to be described later is indicated by an X1 direction, and the opposite direction is indicated by an X2 direction. Note that a rotation center axis C of the rotary electrical machine 100 extending along the shaft 11 extends in the X direction.

In each drawing, the radial direction of the shaft 11 is indicated by a Y direction. Furthermore, the outside in the radial direction of the shaft 11 is indicated by a Y1 direction, and the opposite direction is indicated by a Y2 direction.

In each drawing, the circumferential direction of the shaft 11 is indicated by an R direction.

As illustrated in FIG. 1, the rotary electrical machine 100 includes a rotor 101, a stator 102, and a motor housing 103 that covers the rotor 101 and the stator 102.

The motor housing 103 covers the rotor 101 and the stator 102 from the outside in the radial direction and also from the both sides in the axial direction. That is, the motor housing 103 covers entirety of the rotor 101 and the stator 102. The motor housing 103 includes a housing case 3 and a housing cover 4.

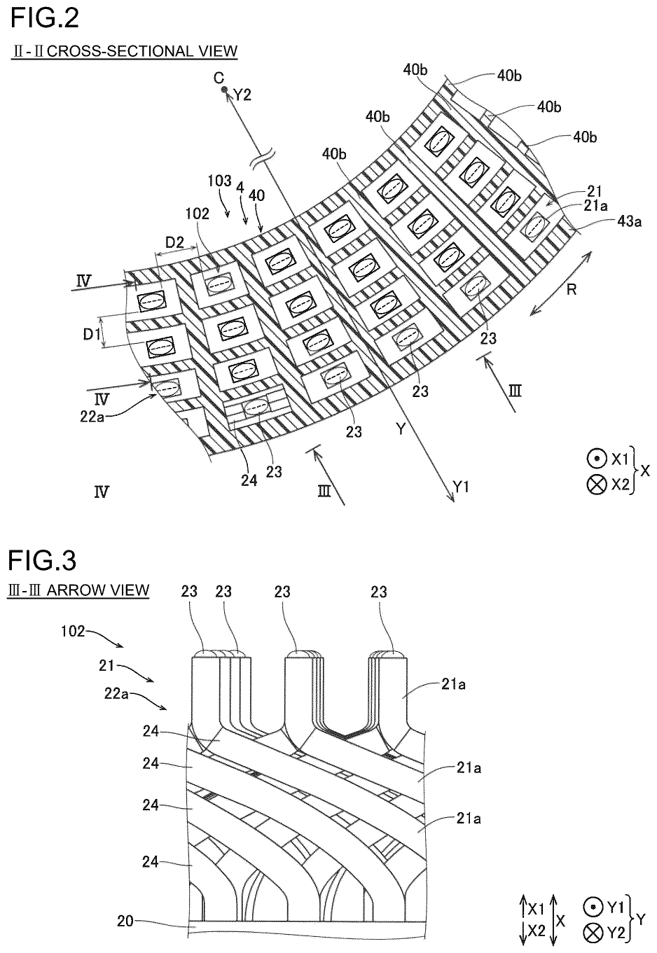

Here, a wall-shaped insulating part 40 (see FIG. 2) is provided integrally with the housing cover 4 of the present embodiment. The housing cover 4 is configured to dispose the insulating part 40 between adjacent joining parts 23 by being attached to the housing case 3. As a result, the insulating part 40 insulates the adjacent joining parts 23 from each other. Details will be described later.

### (Configuration of Rotor)

The rotor 101 includes a rotor core 10 and the shaft 11.

The rotor 101 is disposed inside in the radial direction of the stator 102 so as to face the stator 102. That is, the rotary electrical machine 100 is configured as an inner rotor type rotary electrical machine.

The rotor core 10 is formed in an annular shape. The rotor core 10 is configured by stacking a plurality of electromagnetic steel sheets in the axial direction. The rotor core 10 is configured to allow a magnetic flux to pass therethrough. The rotor core 10 includes a shaft insertion hole 10a and a plurality of magnet holes (not illustrated) in which permanent magnets are disposed.

The shaft 11 is a shaft portion serving as a rotation center of the rotary electrical machine 100. As an example, the shaft 11 is formed of a steel material.

### (Configuration of Stator)

The stator 102 includes a stator core 20 and a coil 21 disposed in the stator core 20.

The stator core 20 is formed by stacking a plurality of electromagnetic steel sheets in the axial direction, and is configured to allow a magnetic flux to pass therethrough. The stator core 20 is provided with a slot (not illustrated) which is a space for passing the coil 21 in the axial direction, and a tooth (not illustrated) around which the coil 21 is wound.

The coil 21 is connected to an external power supply, and is configured to be supplied with electric power (for example, three-phase AC power). The coil 21 is configured to generate a magnetic field by being supplied with electric power.

The coil 21 has a coil end part 22a (see FIG. 3) that protrudes from the stator core 20 to one side (X1 direction side) in the axial direction and a coil end part 22b that protrudes from the stator core 20 to the other side (X2 direction side) in the axial direction.

The coil end part 22b is led out from one slot on the other side (X2 direction side) in the axial direction of the stator core 20, folded back, and introduced into another slot.

As illustrated in FIG. 3, in the coil 21, a plurality of joining parts 23 that join segment conductors 21a to each other are provided on the one side in the axial direction. Specifically, the coil 21 (coil end part 22a) has insulating films 24 and the joining parts 23 from which the insulating films 24 are peeled off. The joining part 23 is formed by joining two in-phase metal conductive wire portions exposed by peeling the insulating films 24.

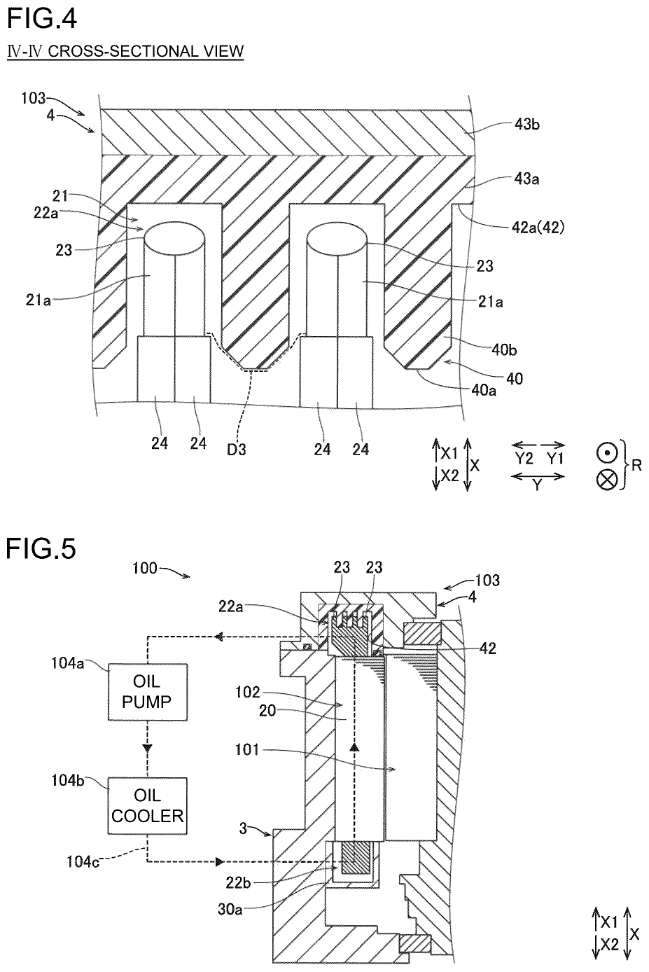

As an example, joining that forms the joining part 23 is Tig welding. As a result of the Tig welding, the end part on the one side in the axial direction of the joining part 23 has a rounded shape (see FIG. 4). Therefore, the joining part 23 is formed to be tapered toward the one side (X1 direction side) in the axial direction. The joining part 23 is not covered with an insulating resin or the like, and a metal conductive wire portion is exposed. Note that, in the present embodiment, entirety of the portion where the insulating film 24 is peeled off (exposed metal conductive wire portion) will be described as the joining part 23.

As illustrated in FIG. 2, the plurality of segment conductors 21a constituting the coil end part 22a are arranged in a plurality of rows in the radial direction and the circumferential direction. The plurality of segment conductors 21a constituting the coil end part 22a are alternately bent to one side in the circumferential direction and the other side in the circumferential direction row by row from the inside (innermost row) in the radial direction toward the outside (outermost row) in the radial direction. Then, the end parts of the two segment conductors 21a in the adjacent rows in the radial direction bent in the opposite directions are joined after the insulating films 24 are peeled off, thereby forming the joining part 23.

The joining part 23 of the coil 21 extends toward the one side in the axial direction (X1 direction) separated from the stator core 20 (see FIG. 3). The joining part 23 extends linearly toward the one side in the axial direction.

The plurality of joining parts 23 are provided in the coil end part 22a. The plurality of joining parts 23 are arranged in a plurality of rows so as to be aligned in the radial direction and the axial direction, and are arranged in an annular shape as a whole. The joining parts 23 aligned in the radial direction are arranged at equal intervals at a distance D1 in the radial direction. The joining parts 23 aligned in the circumferential direction are arranged at equal intervals at a distance D2 in the circumferential direction. The distance D1 in the radial direction is smaller than the distance D2 in the circumferential direction (D1<D2).

### (Configuration of Motor Housing)

As illustrated in FIG. 1, the insulating part 40 that is disposed between the adjacent joining parts 23 and insulates the adjacent joining parts 23 from each other is provided integrally with the motor housing 103. Specifically, the motor housing 103 includes the hollow housing case 3 having an opening 33 and the housing cover 4 attached to the housing case 3 so as to close the opening 33. The insulating part 40 is provided integrally with the housing cover 4.

The housing case 3 includes a cylindrical side wall part 31 to which the stator core 20 is fixed on the inner peripheral surface, a circular bottom wall part 32 provided at an end part on the other side (X2 direction side) in the axial direction of the cylindrical side wall part 31, and the above-described opening 33 provided at an end part on the one side (X1 direction side) in the axial direction of the cylindrical side wall part 31.

A cover part 30a that covers the coil end part 22b on the other side (X2 direction side) in the axial direction is provided in the housing case 3. The cover part 30a may be configured integrally with the housing case 3 or may be configured separately.

The housing cover 4 is configured to be fixed to the housing case 3 by a fixing member F in a state of being positioned with respect to the housing case 3 in which the rotor 101 and the stator 102 are accommodated. As an example, the housing cover 4 is attached to the housing case 3 by a bolt having a positioning function as the fixing member F. Note that the housing cover may be attached to the housing case by a positioning pin, a bolt having no positioning function, or the like. A plurality of the fixing members F are provided at predetermined angular intervals along the outer edge on the outside in the radial direction of the housing cover 4.

When the housing cover 4 is attached to the housing case 3, a seal member S is installed between the housing cover 4 and the housing case 3. Specifically, the seal member S is disposed along an end surface 41 of the housing cover 4 on the stator core 20 side (X2 direction side). Furthermore, the seal member S is an annular member disposed around the shaft 11, and is installed on each of the outside in the radial direction of a recess 42 to be described later of the housing cover 4 and on the inside in the radial direction of the recess 42.

As an example, the seal member S is an O-ring. Note that the seal member may be a sheet-like sealing member or the like. The seal member S has a function of preventing a refrigerant to be described later flowing in the recess 42 from leaking from the recess 42. Although not illustrated, a similar seal member is also installed in the cover part 30a of the housing case 3.

The recess 42 recessed toward the one side in the axial direction (X1 direction) separated from the stator core 20 is provided in the end surface 41 of the housing cover 4 on the stator core 20 side (X2 direction side). In the recess 42 of the housing cover 4, a sealed closed space is formed by the housing case 3 and the stator core 20. The housing cover 4 is in contact with the housing case 3 at the end surface 41 on the outside in the radial direction of the recess 42, and is in contact with the stator core 20 at the end surface 41 on the inside in the radial direction of the recess 42. The insulating part 40 is disposed on a bottom surface portion 42a on the one side (X1 direction side) in the axial direction of the recess 42.

The insulating part 40 protrudes from a motor housing 103 main body (bottom surface portion 42a) to the other side (X2 direction) in the axial direction. Therefore, entirety of the insulating part 40 is disposed in the recess 42. Note that the above-described motor housing 103 main body means a portion obtained by removing the insulating part 40 from the housing case 3.

A front end part 40a on the other side in the axial direction of the insulating part 40 is formed to be tapered toward the other side (see FIG. 4). As an example, the front end part 40a is subjected to chamfering processing in which an edge part is formed obliquely. Note that the front end part may be subjected to round chamfering processing in which an edge part is formed in an arc shape.

As illustrated in FIG. 2, the insulating part 40 has a plurality of rows of wall parts 40b extending in the radial direction and the axial direction. The insulating part 40 is formed in a lattice shape in which the plurality of rows of wall parts 40b partition the plurality of joining parts 23. In the insulating part 40, the joining part 23 is disposed at a substantially central position of two wall parts 40b adjacent to each other in the circumferential direction. In the insulating part 40, the joining part 23 is disposed at a substantially central position of two wall parts 40b adjacent to each other in the radial direction. Note that the insulating part 40 may be in contact with the joining part 23. As an example, the thickness of the wall part 40b extending in the radial direction is larger than the thickness of the wall part 40b extending in the circumferential direction.

As illustrated in FIG. 4, the front end part 40a on the other side (X2 direction side) in the axial direction of the insulating part 40 extends to the space between the adjacent insulating films 24 beyond the joining parts 23. That is, the insulating part 40 is always disposed between the adjacent joining parts 23 in the radial direction and the circumferential direction. Therefore, the insulating part 40 can secure a relatively large insulation distance D3 (the length of the portion indicated by the bent broken line) for the joining parts 23 arranged in the radial direction through the space on the other side (X2 direction side) in the axial direction of the front end part 40a of the insulating part 40. Naturally, the insulation distance D3 is larger than the distance D1 (see FIG. 2) between the joining parts 23 aligned in the radial direction.

Note that the insulation distance D3 between the two joining parts 23 adjacent in the radial direction is smaller than the insulation distance (not illustrated) 3 between the two joining parts 23 adjacent in the circumferential direction. This is because, as described above, the distance D1 (see FIG. 2) between the joining parts 23 aligned in the radial direction is smaller than the distance D2 (see FIG. 2) between the joining parts 23 aligned in the circumferential direction.

As illustrated in FIG. 5, the recess 42 is configured such that a refrigerant for cooling the joining parts 23 (coil 21) flows therein. As an example, the refrigerant is cooling oil. Specifically, in the rotary electrical machine 100, an oil pump 104a, an oil cooler 104b, and an oil circulation path 104c for circulating oil in the recess 42 are provided. The oil cooled by the oil cooler 104b is sent into the recess 42 by the oil pump 104a.

As a detailed flow of the oil, first, the oil is supplied from the oil cooler 104b to the coil end part 22b (in the cover part 30a) on the other side (X2 direction side) in the axial direction by the oil pump 104a. Then, the oil is supplied into the recess 42 through a refrigerant hole (not illustrated) provided in the stator core 20 and extending in the axial direction. After the oil is circulated in the circumferential direction in the recess 42, the oil is returned to the oil cooler 104b.

The housing cover 4 includes a resin cover part 43a in which the insulating part 40 is integrally provided, the resin cover part 43a being made of resin (for example, made of PPS resin), and a metal cover part 43b that supports the shaft 11, the metal cover part 43b being made of metal (for example, made of aluminum). As an example, the housing cover 4 is formed by insert molding.

The resin cover part 43a integrally includes the insulating part 40 and a peripheral portion of the insulating part 40 that surrounds the insulating part 40. The metal cover part 43b covers the resin cover part 43a from the one side in the axial direction, outside in the radial direction, and inside in the radial direction. The metal cover part 43b supports the shaft 11 through a bearing 11a. The resin cover part 43a is provided at a position in contact with the refrigerant in the recess 42, while the metal cover part 43b is not in contact with the refrigerant in the recess 42. Therefore, the housing cover 4 has a structure in which heat is hardly transferred from the refrigerant in the recess 23 by the resin cover part 43a. Therefore, the housing cover 4 can suppress heat dissipation from the refrigerant in the recess 23 through the housing cover 4.

### (Method for Assembling Rotary Electrical Machine)

A method for assembling (method for manufacturing) the rotary electrical machine 100 will be described with reference to FIGS. 1 and 4.

The method for assembling the rotary electrical machine 100 includes, as a first process, a process of accommodating the rotor 101 and the stator 102 in the housing case 3.

Specifically, in the first process, the stator core 20 is fixed to the inner peripheral surface of the housing case 3 by shrink fitting or the like. Furthermore, the rotor 101 is disposed inside in the radial direction of the stator core 20.

Next, the method for assembling the rotary electrical machine 100 includes, as a second process, a process of attaching the housing cover 4 to the housing case 3 and disposing the insulating part 40 between the adjacent joining parts 23.

Specifically, as the second process, the housing cover 4 is attached to the housing case 3 by the fixing members F. At this time, the housing cover 4 is attached to the housing case 3 in a state where the housing cover 4 is movable only in the axial direction with respect to the housing case 3 by using a predetermined guide. As a result, the front end part 40a on the other side in the axial direction of the insulating part 40 is in a state of extending to the space between the adjacent insulating films 24 beyond the joining parts 23. Furthermore, interference between the joining part 23 and the insulating part 40 both of which extend in the axial direction can be avoided by the predetermined guide. Note that, as the predetermined guide, the shaft 11, the fixing member F having a positioning function, or the like may be used, or another structure may be used.

As described above, in the method for assembling the rotary electrical machine 100, the insulating part 40 can be disposed between the adjacent joining parts 23 to achieve insulation between the adjacent joining parts 23 by the insulating part 40 only by attaching the housing cover 4 to the housing case 3. Therefore, in the method for manufacturing the rotary electrical machine 100, a dedicated process for insulation in which the joining part 23 (conductor) is directly covered with a resin film, a powder film, or the like is not necessary. Furthermore, the rotary electrical machine 100 can be downsized as a whole by the amount corresponding to the unnecessary resin coating, powder coating, or the like described above for insulation.

### (Effects of Embodiment)

In the present embodiment, the following effects can be obtained.

In the present embodiment, as described above, the insulating part 40 that is disposed between the adjacent joining parts 23 and insulates the adjacent joining parts 23 from each other is provided integrally with the motor housing 103 that covers the rotor 101 and the stator 102. As a result, unlike the conventional structure including both a cover having an insulating part and a case that covers a rotor, a stator, and the cover (a structure in which connecting parts are covered with a double layer and adjacent connecting parts are insulated from each other by the insulating part), the adjacent joining parts 23 can be insulated from each other only by the motor housing 103 in which the insulating part 40 is integrally provided, the motor housing 103 covering the rotor 101 and the stator 102. As a result, since the number of components of the rotary electrical machine 100 can be reduced, the structure can be simplified in the configuration in which the insulating part 40 is disposed between the adjacent joining parts 23 of the coil 21 for insulation. Furthermore, since a conventional cover is unnecessary, the rotary electrical machine 100 can be downsized. Furthermore, it is not necessary to assemble a double cover as in the conventional art, and the assembly process of the rotary electrical machine 100 can be simplified.

In the present embodiment, as described above, the motor housing 103 includes the hollow housing case 3 having the opening 33, and the housing cover 4 in which the insulating part 40 is integrally provided, the housing cover 4 being attached to the housing case 3 so as to close the opening 33, and the housing cover 4 is configured to dispose the insulating part 40 between the adjacent joining parts 23 by being attached to the housing case 3. As a result, the insulating part 40 can be disposed between the adjacent joining parts 23 and the adjacent joining parts 23 can be insulated from each other only by attaching the housing cover constituting the motor housing 103 to the housing case 3.

In the present embodiment, as described above, the housing cover 4 includes: the resin cover part 43a in which the insulating part 40 is integrally provided, the resin cover part 43a being made of resin; and the metal cover part 43b that supports the shaft 11, the metal cover part 43b being made of metal. As a result, insulation between the adjacent joining parts 23 can be secured by the resin cover part 43a in which the insulating part 40 is integrally provided, the resin cover part 43a being made of resin, and the shaft 11 can be stably supported by the metal cover part 43b made of metal and having higher rigidity than that of the resin cover part 43a made of resin.

In the present embodiment, as described above, the joining part 23 of the coil 21 extends toward the one side in the axial direction separated from the stator core 20, the coil 21 includes the insulating films 24 and the joining parts 23 from which the insulating films 24 are peeled off, the insulating part 40 protrudes from the motor housing 103 main body toward the other side in the axial direction, and the front end part 40a of the insulating part 40 on the other side in the axial direction extends to a space between the adjacent insulating films 24 beyond the joining parts 23. As a result, since the front end part 40a of the insulating part 40 extends to the space between the adjacent insulating films 24 beyond the joining parts 23, a large insulation distance (separation distance between the conductors to be secured so as not to cause a short circuit through the space between the conductors) (D3) between the adjacent joining parts 23 can be secured by disposing the insulating part 40 in the entire space between the adjacent joining parts 23.

In the present embodiment, as described above, the front end part 40a on the other side in the axial direction of the insulating part 40 is formed to be tapered toward the other side. As a result, the insulating part 40 can be easily inserted and disposed between the adjacent joining parts 23 by using the tapered front end part 40a of the insulating part 40.

In the present embodiment, as described above, the recess 42 recessed toward the one side in the axial direction separated from the stator core 20 is provided in the end surface 41 of the housing cover 4 on the stator core 20 side, the insulating part 40 is disposed in the bottom surface portion 42a of the recess 42 on the one side in the axial direction, and the recess 42 is configured such that a refrigerant for cooling the joining parts 23 flows inside. As a result, the refrigerant flowing through the recess 42 is brought into direct contact with the joining part 23 (conductor) for heat exchange, so that the coil end part 22a can be effectively cooled.

In the present embodiment, as described above, the insulating part 40 has the plurality of rows of wall parts 40b that extend in respective directions of the radial direction and the axial direction, and is formed in a lattice shape in which the plurality of rows of wall parts 40b partition the plurality of joining parts 23. As a result, since the plurality of joining parts 23 can be partitioned by the insulating part 40 formed in a lattice shape by the plurality of rows of wall parts 40b, insulation between the adjacent joining parts 23 can be more effectively secured.

### (Modification)

Note that it should be understood that the embodiment disclosed herein is illustrative in all respects and is not restrictive. The scope of the present disclosure is defined not by the description of the embodiment described above but by the claims, and further includes meanings equivalent to the claims and all changes (modifications) within the scope.

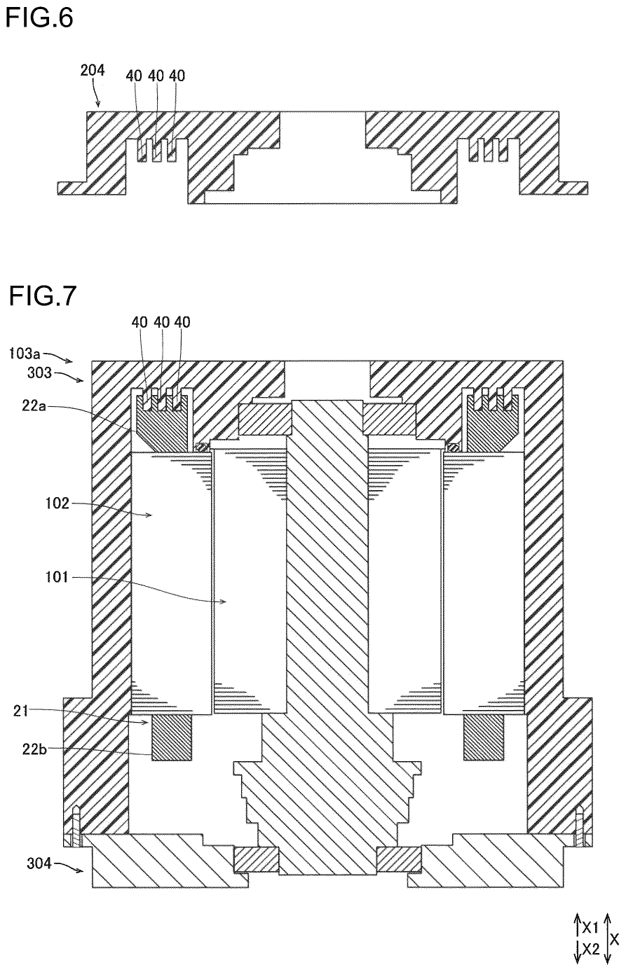

For example, in the above-described embodiment, an example in which the housing cover includes the resin cover part made of resin and the metal cover part made of metal has been described, but the present disclosure is not limited thereto. In the present disclosure, as illustrated in FIG. 6, a housing cover 204 may be formed only of resin. Specifically, the entire housing cover 204 including the insulating part 40 is made of resin, and the housing cover 204 is configured to dispose the insulating part 40 made of resin between the adjacent joining parts 23 (see FIG. 1).

Furthermore, in the above-described embodiment, the example in which the insulating part is provided in the housing cover has been described, but the present disclosure is not limited thereto. In the present disclosure, as in a motor housing 103a illustrated in FIG. 7, the insulating part 40 may be provided in a housing case 303 instead of a housing cover 304. In this case, the housing cover 304 is disposed on the coil end part 22b side on the other side (X2 direction) in the axial direction.

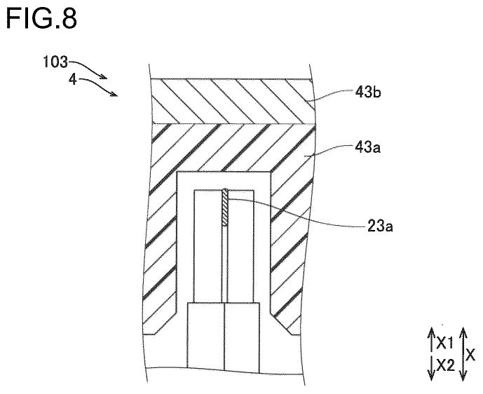

Furthermore, in the above-described embodiment, the example in which the joining part is formed by Tig welding has been described, but the present disclosure is not limited thereto. In the present disclosure, as illustrated in FIG. 8, a joining part 23a may be formed by laser welding.

Furthermore, in the above-described embodiment, the example in which the oil flows from the coil end part on the other side in the axial direction to the coil end part on the one side in the axial direction through the stator core has been described, but the present disclosure is not limited thereto. In the present disclosure, the oil may be directly supplied from the oil pump to each of the coil end part on the other side in the axial direction and the coil end part on the one side in the axial direction.

Furthermore, in the above-described embodiment, the example in which the rotary electrical machine is cooled only by the oil has been described, but the present disclosure is not limited thereto. In the present disclosure, the rotary electrical machine may be cooled by not only oil but also water. For example, a pipe line in contact with the outer peripheral surface of the stator core may be provided to cool the stator core by causing water to flow through the pipe line.

Furthermore, in the above-described embodiment, the example in which the insulating part includes the lattice-shaped wall part has been described, but the present disclosure is not limited thereto. In the present disclosure, the insulating part may include only a plurality of annular wall parts that extend in the circumferential direction. In addition, the insulating part may include only a plurality of linear wall parts that extend in the radial direction. Furthermore, one cylindrical insulating part or the like may be provided for each joining part. In this case, the joining part is disposed in the cylindrical insulating part to perform insulation.

Furthermore, in the above-described embodiment, the example in which the housing cover is formed by insert-molding the resin cover part of the housing cover and the metal cover part of the housing cover has been described, but the present disclosure is not limited thereto. In the present disclosure, the housing cover may be formed by fastening the resin cover part of the housing cover and the metal cover part of the housing cover with a bolt. In addition, the housing cover may be formed, for example, by bonding the resin cover part of the housing cover and the metal cover part of the housing cover.

### REFERENCE SIGNS LIST

3: Housing case, 4, 204: Housing cover, 10: Shaft, 20: Stator core, 21: Coil, 21a: Segment conductor, 22a: Coil end part, 23, 23a: Joining part, 24: Insulating film, 33: Opening (of housing case), 40: Insulating part, 40a: Front end part (of insulating part), 43a: Resin cover part (of housing cover), 43b: Metal cover part (of housing cover), 100: Rotary electrical machine, 101: Rotor, 102: Stator, and 103, 103a: Motor housing

1. A rotary electrical machine comprising:
a rotor including a shaft;
a stator including a stator core and a coil in which a plurality of joining parts that join segment conductors to each other are provided on one side in an axial direction, the coil having a coil end part that protrudes from the stator core to the one side in the axial direction; and
a motor housing that covers the rotor and the stator,
wherein
an insulating part that is disposed between the plurality of joining parts adjacent to each other and insulates the plurality of joining parts adjacent to each other from each other is provided integrally with the motor housing.

2. The rotary electrical machine according to claim 1,
wherein the motor housing includes
a hollow housing case having an opening, and
a housing cover in which the insulating part is integrally provided, the housing cover being attached to the hollow housing case so as to close the opening, and
the housing cover is configured to dispose the insulating part between the plurality of joining parts adjacent to each other by being attached to the hollow housing case.

3. The rotary electrical machine according to claim 2, wherein the housing cover includes a resin cover part in which the insulating part is integrally provided, the resin cover part being made of resin, and a metal cover part that supports the shaft, the metal cover part being made of metal.

4. The rotary electrical machine according to claim 1,
wherein the plurality of joining parts of the coil extend toward the one side in the axial direction separated from the stator core,
the coil includes insulating films and the plurality of joining parts from which the insulating films are peeled off,
the insulating part protrudes from a motor housing main body toward another side in the axial direction, and
a front end part of the insulating part on the another side in the axial direction extends to a space between the insulating films adjacent to each other beyond the plurality of joining parts.
